(19) United States
(12) Patent Application Publication
(10) Pub. No.: US 2023/0112102 A1
(43) Pub. Date: Apr. 13, 2023

(54) HYDROGEN TANK-LOADED VEHICLE

(71) Applicant: TOYOTA JIDOSHA KABUSHIKI KAISHA, Toyota-shi Aichi-ken (JP)

(72) Inventors: Zixun MEI, Edogawa-ku Tokyo-to (JP); Nobuyuki TOMATSU, Nagoya-shi Aichi-ken (JP); Hiroyuki KOBAYASHI, Mitaka-shi Tokyo-to (JP)

(73) Assignee: TOYOTA JIDOSHA KABUSHIKI KAISHA, Toyota-shi Aichi-ken (JP)

(21) Appl. No.: 17/898,899

(22) Filed: Aug. 30, 2022

(30) Foreign Application Priority Data
Oct. 8, 2021 (JP) 2021-166468

(51) Int. Cl. B60P 3/22; H01M 8/04089; H01M 8/04082

(52) U.S. Cl. CPC B60P 3/2215; H01M 8/04089; H01M 8/04201; B60L 50/70

(57) ABSTRACT

A hydrogen tank-loaded vehicle includes: a tank storage portion disposed at a main body unit that is movable by driving of driving wheels, the tank storage portion structuring a portion of a vehicle outer profile, and a plurality of hydrogen tank mounting portions being provided at the tank storage portion in a height direction of the main body unit, each hydrogen tank mounting portion being configured to removably store a hydrogen tank; and a fuel cell stack that is supplied with hydrogen from the hydrogen tanks and generates electric power.

### CROSS-REFERENCE TO RELATED APPLICATION

This application claims priority under 35 USC 119 from Japanese Patent Application No. 2021-166468 filed on Oct. 8, 2021, the disclosure of which is incorporated by reference herein in its entirety.

### BACKGROUND

### Technical Field

The present disclosure relates to a hydrogen tank-loaded vehicle.

### Related Art

Japanese Patent Application Laid-Open (JP-A) No. 2009-270707, for example, discloses a technology in which a hydrogen storage body case that stores plural hydrogen tanks is accommodated in a trunk of a vehicle.

With this technology, a connector is provided at the hydrogen storage body case and is connected to another connector provided at a rear under floor of the trunk. The hydrogen tanks and a hydrogen fuel cell system of the vehicle are linked by this connection.

### SUMMARY

However, in the technology described above, loading and removal of the hydrogen storage body case is conducted through the trunk. Therefore, it is necessary to prevent obstacles being disposed in a movement path of the hydrogen storage body case, and space in the trunk must be increased. As a result, the vehicle itself may become larger.

An object of the present disclosure is to provide a hydrogen tank-loaded vehicle that may be formed compactly.

A hydrogen tank-loaded vehicle according to a first aspect of the present disclosure includes: a tank storage portion disposed at a main body unit that is movable by driving of driving wheels, the tank storage portion structuring a portion of a vehicle outer profile, and a plurality of hydrogen tank mounting portions being provided at the tank storage portion in a height direction of the main body unit, each hydrogen tank mounting portion being configured to removably store a hydrogen tank; and a fuel cell stack that is supplied with hydrogen from the hydrogen tanks and generates electric power.

The hydrogen tank-loaded vehicle according to the first aspect is equipped with the tank storage portion and the fuel cell stack. The tank storage portion is disposed at the main body unit that can be moved by driving of the driving wheels. The tank storage portion structures a portion of the vehicle outer profile. The plural hydrogen tank mounting portions in which the hydrogen tanks can be removably stored are provided in the tank storage portion, and the plural hydrogen tank mounting portions are arranged in the height direction of the main body unit. The fuel cell stack is supplied with hydrogen from the hydrogen tanks and generates electric power.

The tank storage portion in which the hydrogen tanks are removably stored structures a portion of the vehicle outer profile of the hydrogen tank-loaded vehicle. That is, the tank storage portion is provided at an outer side of the hydrogen tank-loaded vehicle.

If, for example, a tank storage portion is provided at an interior side of a hydrogen tank-loaded vehicle, it is difficult to mount or unmount a hydrogen tank directly from outside the hydrogen tank-loaded vehicle. With the present disclosure, by contrast, because the tank storage portion is provided at the outer side of the hydrogen tank-loaded vehicle, hydrogen tank mounting and unmounting operations are simpler, and ease of operations is improved.

Because the tank storage portion is provided at the outer side of the hydrogen tank-loaded vehicle, when a hydrogen tank is mounted or unmounted, there is no obstacle in a movement path of the hydrogen tank. Therefore, it is sufficient to reserve space in which the hydrogen tanks can be stored for the tank storage portion, and the main body unit may be formed compactly.

In a hydrogen tank-loaded vehicle according to a second aspect of the present disclosure, in the hydrogen tank-loaded vehicle according to the first aspect, the tank storage portion is exposed at the exterior.

In the hydrogen tank-loaded vehicle according to the second aspect, the tank storage portion is exposed to the exterior. Therefore, in contrast to, for example, a structure in which a tank storage portion is not exposed to the exterior due to a cover or the like, there is no need to remove the cover or the like. Thus, hydrogen tank mounting and unmounting operations are even easier and ease of operations is further improved.

In a hydrogen tank-loaded vehicle according to a third aspect of the present disclosure, in the hydrogen tank-loaded vehicle according to the first aspect or the second aspect, the driving wheels are provided at a front side of the main body unit, and the tank storage portion is provided at an upper side relative to the driving wheels.

In the hydrogen tank-loaded vehicle according to the third aspect, the driving wheels are provided at the front side of the main body unit, and the tank storage portion is provided at the upper side relative to the driving wheels. Therefore, the hydrogen tank-loaded vehicle may be formed compactly. In addition, at a time of collision of the main body unit, a direct collision of a collision body against the hydrogen tanks stored in the tank storage portion may be prevented.

In a hydrogen tank-loaded vehicle according to a fourth aspect of the present disclosure, in the hydrogen tank-loaded vehicle according to any of the first to third aspects, the hydrogen tanks are configured to be removable from a front side of the main body unit.

In the hydrogen tank-loaded vehicle according to the fourth aspect, because the hydrogen tanks may be mounted and unmounted from the front side of the main body unit, safety of a mounting operator when mounting or unmounting a hydrogen tank may be assured.

In a hydrogen tank-loaded vehicle according to a fifth aspect of the present disclosure, the hydrogen tank-loaded vehicle according to any one of the first to fourth aspects, further includes a lock mechanism that is configured to enable mounting or removal of each hydrogen tank at a hydrogen tank mounting portion.

In the hydrogen tank-loaded vehicle according to the fifth aspect, lock mechanisms that enable mounting or removal of each hydrogen tank at a hydrogen tank mounting portion are provided. Therefore, a hydrogen tank coming loose from a hydrogen tank mounting portion during movements of the main body unit may be prevented.

In a hydrogen tank-loaded vehicle according to a sixth aspect of the present disclosure, in the hydrogen tank-loaded vehicle according to the fifth aspect, the lock mechanism includes a cam groove provided at each hydrogen tank mounting portion, a projection portion provided at each hydrogen tank being configured to engage with the cam groove, and the cam groove converting rotary movement in a circumferential direction of each hydrogen tank to linear movement in an axial direction thereof.

In the hydrogen tank-loaded vehicle according to the sixth aspect, the cam groove is provided at each hydrogen tank mounting portion and the projection portion is provided at each hydrogen tank. The projection portion is engaged with the cam groove. Via the projection portion, rotary movement of the hydrogen tank in the circumferential direction is converted to linear movement in the axial direction of the hydrogen tank by the cam groove.

In a hydrogen tank-loaded vehicle according to a seventh aspect of the present disclosure, in the hydrogen tank-loaded vehicle according to the sixth aspect, a handle portion that enables handling is provided at one end in a length direction of each hydrogen tank, and a locked state or lock release state of the hydrogen tank by the locking mechanism can be verified from an exterior by a position of the handle portion relative to a hydrogen tank mounting portion.

In the hydrogen tank-loaded vehicle according to the seventh aspect, the handle portion is provided at the length direction one end of each hydrogen tank, and each hydrogen tank may be handled via the handle portion. A locked state or lock release state of the hydrogen tank by the lock mechanism may be verified from the exterior by the position of the handle portion.

In a hydrogen tank-loaded vehicle according to an eighth aspect of the present disclosure, in the hydrogen tank-loaded vehicle according to any one of the first to seventh aspects, the main body unit includes a frame portion that structures an outer profile of the main body unit, and a cavity portion that penetrates in an axial direction of the driving wheels through an inner side of the frame portion.

In the hydrogen tank-loaded vehicle according to the eighth aspect, the main body unit includes the frame portion and the cavity portion. The cavity portion penetrates in the axial direction of the driving wheels through the inner side of the frame portion structuring the outer profile of the main body unit. Versatility of the hydrogen tank-loaded vehicle may be improved by utilizing this cavity portion.

In a hydrogen tank-loaded vehicle according to a ninth aspect of the present disclosure, in the hydrogen tank-loaded vehicle according to any one of the first to eighth aspects, a width dimension of the main body unit is smaller than a width dimension of the driving wheels in an axial direction thereof

In the hydrogen tank-loaded vehicle according to the ninth aspect, because the width dimension of the main body unit is formed to be smaller than the width dimension along the axial direction of the driving wheels, the hydrogen tank-loaded vehicle as a whole may be compactly formed.

According to the hydrogen tank-loaded vehicle according to the present disclosure, the vehicle may be loaded with hydrogen tanks but may be formed compactly.

### BRIEF DESCRIPTION OF THE DRAWINGS

FIG. 1 is a perspective view showing a hydrogen tank-loaded vehicle according to a present exemplary embodiment;

FIG. 2 is a perspective view showing a main body unit constituting a portion of the hydrogen tank-loaded vehicle according to the present exemplary embodiment;

FIG. 3 is a side view, corresponding to FIG. 1, showing the hydrogen tank-loaded vehicle according to the present exemplary embodiment;

FIG. 4 is an exploded perspective view showing the main body unit and a driving unit that constitute portions of the hydrogen tank-loaded vehicle according to the present exemplary embodiment;

FIG. 5 is a side view showing structures of the main body unit that constitutes the portion of the hydrogen tank-loaded vehicle according to the present exemplary embodiment;

FIG. 6 is a magnified perspective view of principal portions, showing a state before a hydrogen tank is stored into a hydrogen tank mounting portion, which is a principal portion of the hydrogen tank-loaded vehicle according to the present exemplary embodiment;

FIG. 7 is a magnified perspective view of the principal portions, showing a state in which the hydrogen tank is being stored into the hydrogen tank mounting portion that is a principal portion of the hydrogen tank-loaded vehicle according to the present exemplary embodiment;

FIG. 8A is a front view showing a hydrogen tank and the hydrogen tank mounting portion of the hydrogen tank-loaded vehicle according to the present exemplary embodiment, in a lock release state before the hydrogen tank is locked to the hydrogen tank mounting portion;

FIG. 8B is a side sectional view showing the hydrogen tank mounting portion of the hydrogen tank-loaded vehicle according to the present exemplary embodiment and the hydrogen tank, in the lock release state before the hydrogen tank is locked to the hydrogen tank mounting portion;

FIG. 9A is a front view showing the hydrogen tank mounting portion of the hydrogen tank-loaded vehicle according to the present exemplary embodiment and the hydrogen tank, in a locked state after the hydrogen tank is locked to the hydrogen tank mounting portion;

FIG. 9B is a side sectional view showing the hydrogen tank mounting portion of the hydrogen tank-loaded vehicle according to the present exemplary embodiment and the hydrogen tank, in the locked state after the hydrogen tank is locked to the hydrogen tank mounting portion; and

FIG. 10 is a perspective view, corresponding to FIG. 2, showing a variant example of the main body unit that constitutes the portion of the hydrogen tank-loaded vehicle according to the present exemplary embodiment.

### DETAILED DESCRIPTION

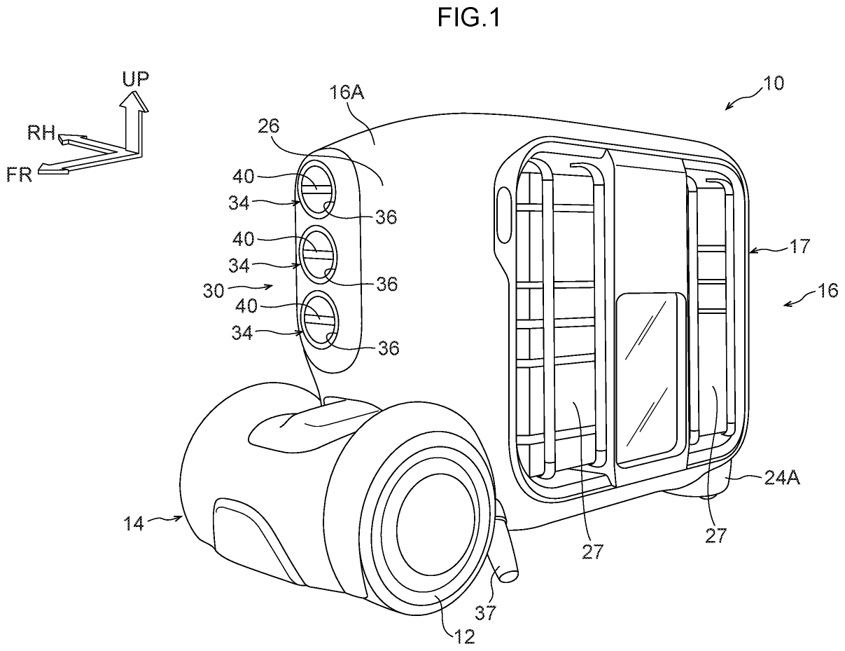

Below, a hydrogen tank-loaded vehicle according to an exemplary embodiment of the present disclosure is described with reference to the attached drawings. The arrow FR marked in FIG. 1 indicates a vehicle front side, the arrow RH indicates a vehicle right side, and the arrow UP indicates a vehicle upper side. Below, unless particularly specified otherwise, the terms front and rear mean front and rear in the front-and-rear direction of the hydrogen tank-loaded vehicle, the terms upper and lower mean upper and lower in the upper-and-lower direction of the hydrogen tank-loaded vehicle, and the terms left and right mean left and right in the left-and-right direction of the hydrogen tank-loaded vehicle.

### Structure of the Hydrogen Tank-Loaded Vehicle

First, structures of the hydrogen tank-loaded vehicle is described.

As shown in FIG. 1, a hydrogen tank-loaded vehicle 10 includes a driving unit 14 provided with wheels (driving wheels) 12, and a main body unit 16 that is movable by driving of the driving unit 14. The driving unit 14 can be coupled to the main body unit 16.

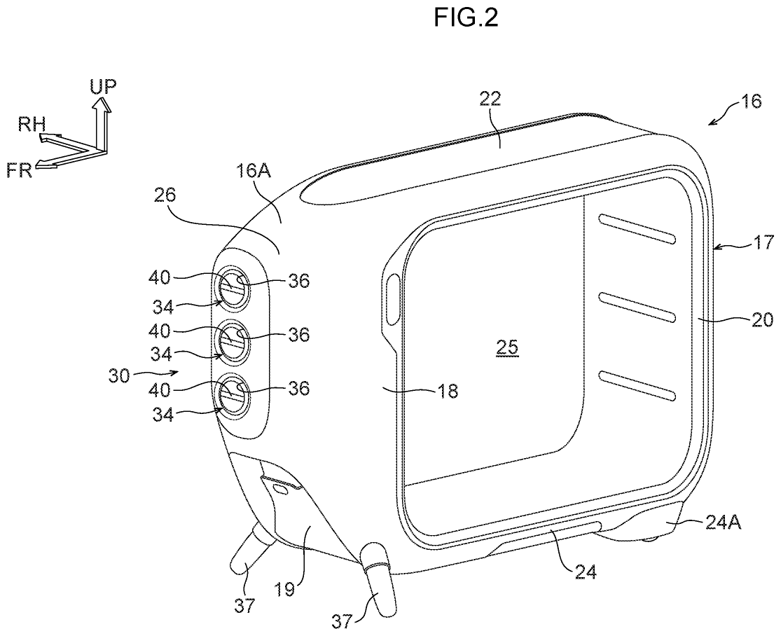

As shown in FIG. 2, the main body unit 16 is provided with a frame portion 17 that forms a rectangular frame shape in a vehicle side view. The frame portion 17 includes a front wall portion 18, a rear wall portion 20, an upper wall portion 22 and a lower wall portion 24. The front wall portion 18 structures a frame at a front portion. The rear wall portion 20 forms the frame at a rear portion and opposes the front wall portion 18. The upper wall portion 22 structures an upper portion and spans between respective upper ends of the front wall portion 18 and the rear wall portion 20. The lower wall portion 24 structures a lower portion and spans between respective lower ends of the front wall portion 18 and the rear wall portion 20.

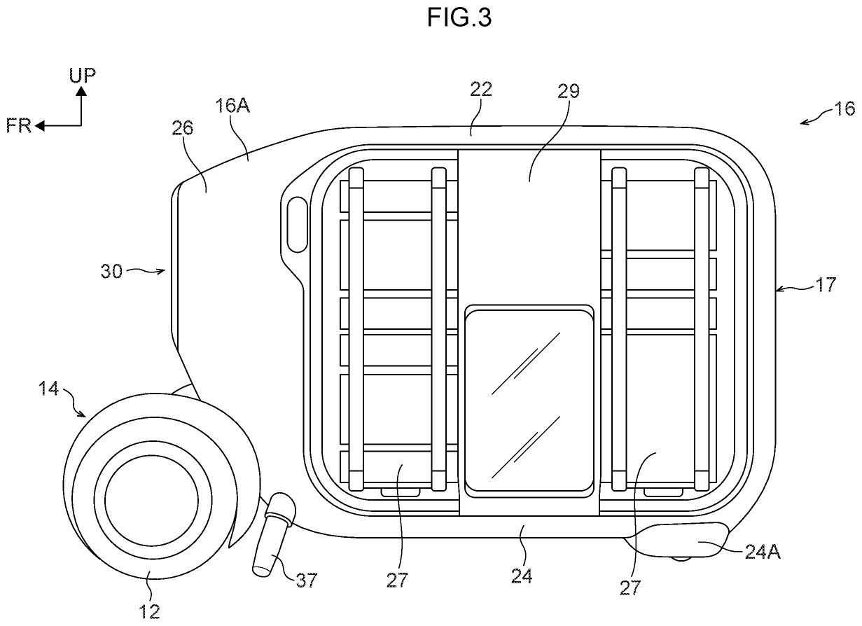

A cavity 25 penetrating in an axial direction of the wheels 12 is formed by the front wall portion 18, rear wall portion 20, upper wall portion 22 and lower wall portion 24. A load 27 that is being transported (see FIG. 3) or the like may be accommodated in the cavity 25.

As shown in FIG. 3, respective side wall portions 29 are provided at the left and right of the main body unit 16, at central portions of the upper wall portion 22 and the lower wall portion 24 in the front-and-rear direction. The side wall portions 29 span between the upper wall portion 22 and the lower wall portion 24. Rigidity of the main body unit 16 is improved by the side wall portions 29, and the load 27 is prevented from falling.

Each side wall portion 29 may be, for example, slidable in the front-and-rear direction, and may be movable so as not to be an obstruction during loading of a load. The size, type and the like of each side wall portion 29 may be appropriately selected in accordance with a running range of the main body unit 16, the size of the load 27 and so forth.

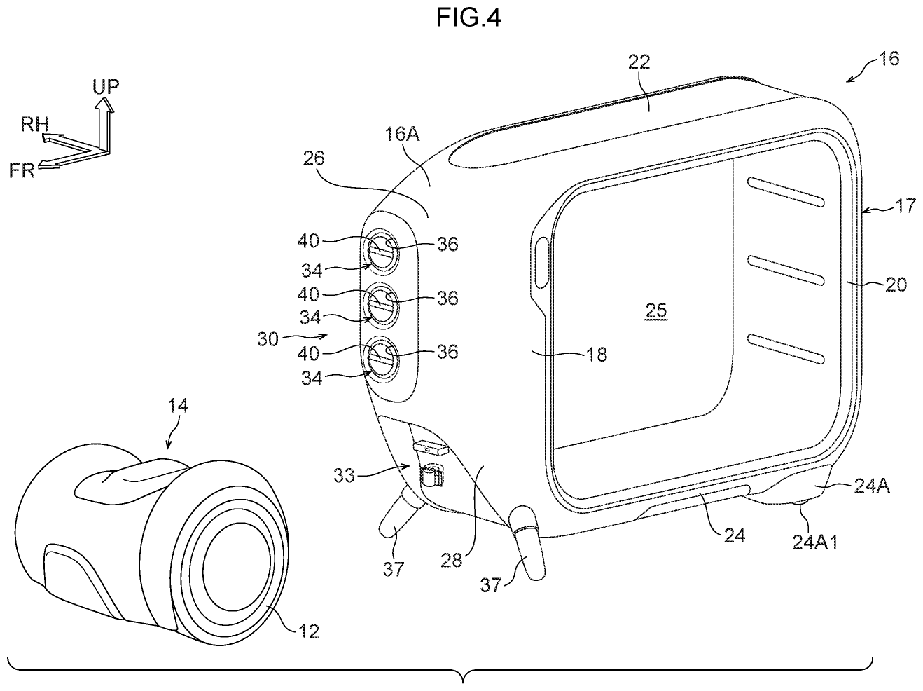

As shown in FIG. 4, the rear wall portion 20, upper wall portion 22 and lower wall portion 24 are formed in board shapes. In contrast, a protruding portion 26 is integrally provided at the front wall portion 18. The protruding portion 26 structures a front portion 16A of the main body unit 16 and protrudes to the front side from the front wall portion 18. The driving unit 14 is coupled to a lower portion of the protruding portion 26. Accordingly, an angled portion 28 is provided at the lower portion of the protruding portion 26. The angled portion 28 is angled toward the lower side while extending to the rear side. A coupler 33, to which the driving unit 14 is coupled, is provided at the angled portion 28.

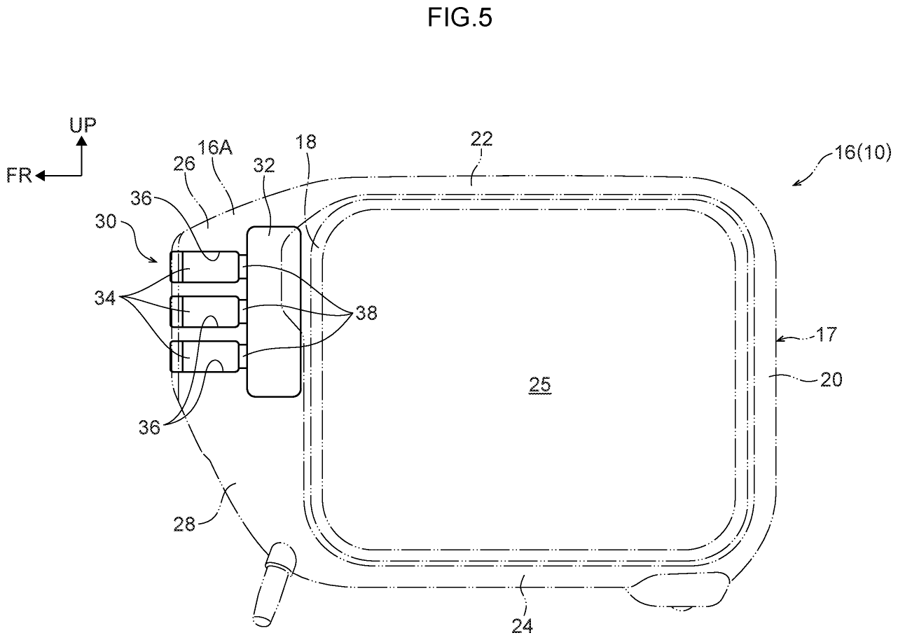

Two of the wheels 12 of the driving unit 14 are provided, spaced apart in the vehicle width direction. The wheels 12 are formed such that a width dimension of the main body unit 16 is smaller than a width dimension of the wheels 12 along the axial direction thereof. A driving motor, which is not shown in the drawings, is provided at the driving unit 14. Electric power may be supplied to the driving motor from a fuel cell stack 32 (see FIG. 5).

A coupling portion, which is not shown in the drawings, is provided at the rear face side of the driving unit 14 (the side thereof at which the main body unit 16 is disposed). The coupling portion can be coupled to the coupler 33 provided at the angled portion 28. In a state in which the coupling portion is coupled to the coupler 33, the main body unit 16 can be moved by the driving unit 14. In a state in which the coupling portion is not coupled to the coupler 33, the coupler 33 may be covered by a cover 19 (see FIG. 2). A coupling structure including this coupler 33 is similar to widely known railway couplers according to, for example, Japanese Patent No. 5,837,668 and the like, and is not described here.

A tracking portion 24A is provided at the lower side of the lower wall portion 24, at the side of the lower wall portion 24 at which the rear wall portion 20 is disposed. Wheels 24A1 are provided at the tracking portion 24A. In the state in which the coupling portion is coupled to the coupler 33, the main body unit 16 can be moved, via the wheels 24A1, by driving of the driving unit 14.

Leg portions 37 are provided at the lower portion of the protruding portion 26. The leg portions 37 are respectively oriented to the lower side from side portions of the protruding portion 26. Lengths of the leg portions 37 may be altered. In the state in which the coupling portion is not coupled to the coupler 33, the lengths of the leg portions 37 are set to be longer to support the side of the main body unit 16 at which the front portion 16A is provided. When the main body unit 16 is to be moved, the lengths of the leg portions 37 are set to be shorter in order to prevent interference with a running surface.

As shown in FIG. 5, a tank storage portion 30 and the fuel cell stack 32 may be accommodated in the protruding portion 26 structuring the front portion 16A of the main body unit 16. As is described in more detail below, a plural number (three in this exemplary embodiment) of hydrogen tank mounting portions 36 are provided in the tank storage portion 30 along the height direction of the main body unit 16. Hydrogen tanks 34 are formed in substantially cylindrical shapes, the interiors of which are charged with hydrogen gas. The hydrogen tanks 34 are removably stored in the hydrogen tank mounting portions 36 in horizontal attitudes.

The fuel cell stack 32 is provided inward from the tank storage portion 30. The hydrogen tank mounting portions 36 are connected with the fuel cell stack 32 via connector portions 38. The fuel cell stack 32 is connected to the hydrogen tanks 34 and to an air compressor (not shown in the drawings). The fuel cell stack 32 generates electric power by an electrochemical reaction between hydrogen supplied from the hydrogen tanks 34 and oxygen in compressed air supplied from the air compressor.

The present exemplary embodiment is structured such that electric power is produced by hydrogen and oxygen being supplied to the fuel cell stack 32, a driving motor is supplied with electric power from the fuel cell stack 32 and drives, and driving force of the driving motor is transmitted to the wheels 12 (see FIG. 1).

### Structure of Hydrogen Tanks

Structures of the hydrogen tanks 34 are now described.

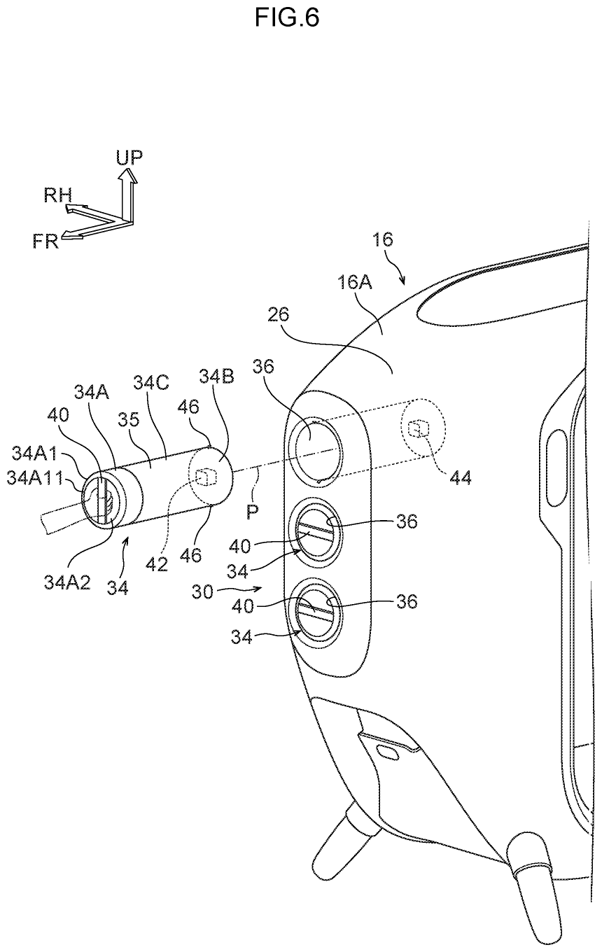

As shown in FIG. 6, the tank storage portion 30 is provided at the protruding portion 26 and constitutes a portion of the outer profile (vehicle profile) of the main body unit 16. The tank storage portion 30 is exposed to the exterior. The hydrogen tanks 34 are provided to be mountable at and removable from the tank storage portion 30.

Each hydrogen tank 34 is formed in a substantially cylindrical shape. The hydrogen tank 34 includes a hydrogen tank main body 35, a handle portion 40 and a square hole portion 42. Hydrogen gas is charged into the interior of the hydrogen tank main body 35. The handle portion 40 is provided at one end portion 34A of the axial direction of the hydrogen tank 34. The square hole portion 42 is provided at another end portion 34B of the axial direction of the hydrogen tank 34.

The handle portion 40 enables handling of the hydrogen tank 34. A recess portion 34A2, whose interior is formed in a substantially cylindrical shape, is formed at the one end portion 34A of the hydrogen tank 34, except at an outer periphery wall 34A1 that structures an outer profile of the hydrogen tank 34. The handle portion 40 is formed to span between the outer periphery wall 34A1 in a diametric direction passing through an axial center P of the hydrogen tank 34.

Because the recess portion 34A2 is provided around the handle portion 40, when a user is holding the hydrogen tank 34, interference with the user's hand is avoided and the handle portion 40 is easy to hold. Because the handle portion 40 spans between portions of the outer periphery wall 34A1, the handle portion 40 may be formed so as not to protrude beyond one end face 34A11 of the hydrogen tank 34, and the handle portion 40 itself may be protected.

The square hole portion 42 is a recess formed in a substantially cuboid shape along the axial center P of the hydrogen tank 34. The square hole portion 42 is engaged with a connector portion 44 that is provided at the hydrogen tank mounting portion 36 structuring the tank storage portion 30. Correspondingly, the connector portion 44 is a protrusion formed in a substantially cuboid shape with which the square hole portion 42 is engaged.

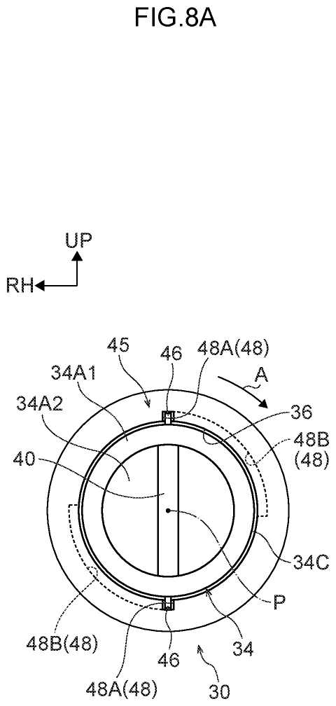

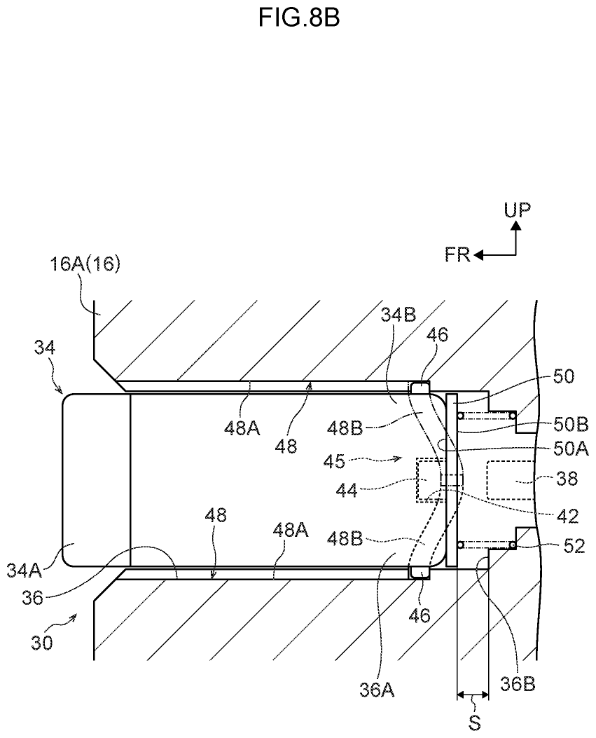

In the present exemplary embodiment, portions of a lock mechanism 45 are provided at the hydrogen tank 34. A pair of engaging protrusions 46 serve as the lock mechanism 45 at the other end portion 34B of the hydrogen tank 34. In a front view of the hydrogen tank 34 and hydrogen tank mounting portion 36, as shown in FIG. 8A, the engaging protrusions 46 are provided projecting in the diametric direction, on a line of extension of the handle portion 40, from an outer periphery face 34C of the hydrogen tank 34. The engaging protrusions 46 are provided at the other end portion 34B of the hydrogen tank 34 (see FIG. 6).

Guide grooves 48 with which the engaging protrusions 46 engage are provided respectively at the upper and lower sides of the hydrogen tank mounting portion 36 in a side sectional view, for example, as shown in FIG. 8B. Each guide groove 48 includes a sliding groove 48A and a cam groove 48B. The sliding groove 48A is formed in the axial direction from a front portion to an inward portion 36A of the hydrogen tank mounting portion 36. The cam groove 48B continues from the sliding groove 48A at the inward portion 36A and is formed substantially diagonally in the axial direction and circumferential direction of the hydrogen tank mounting portion 36.

That is, the sliding grooves 48A guide the hydrogen tank 34, via the engaging protrusions 46, in the axial direction to the inward portion 36A of the hydrogen tank mounting portion 36. Then, when the other end portion 34B of the hydrogen tank 34 reaches the inward portion 36A, the cam grooves 48B guide the hydrogen tank 34, via the engaging protrusions 46, in the axial direction and circumferential direction of the hydrogen tank mounting portion 36 toward the side at which an inward wall portion 36B of the hydrogen tank mounting portion 36 is disposed, which is described below.

An abutting plate 50 is provided at the inward portion 36A. The abutting plate 50 has an outer diameter dimension substantially the same as an outer diameter dimension of the hydrogen tank 34. When the hydrogen tank 34 is moved along the sliding grooves 48A in the axial direction, the hydrogen tank 34 abuts against the abutting plate 50.

The connector portion 44 is provided at the center of a front face 50A of the abutting plate 50. The square hole portion 42 of the hydrogen tank 34 engages with the connector portion 44. Because the square hole portion 42 and connector portion 44 are each formed in a substantially cuboid shape, in the state in which the square hole portion 42 is engaged with the connector portion 44, the square hole portion 42 and connector portion 44 are relatively non-rotatable. That is, the hydrogen tank 34 and the abutting plate 50 are rotatable in an integrated state.

A spring 52 is provided at a rear face 50B side of the abutting plate 50. The abutting plate 50 is urged toward the front side of the hydrogen tank mounting portion 36 by the spring 52. The abutting plate 50 is rotatable about an axial center thereof. The abutting plate 50 is abuttable against the inward wall portion 36B, and the abutting plate 50 is moved by a stroke S.

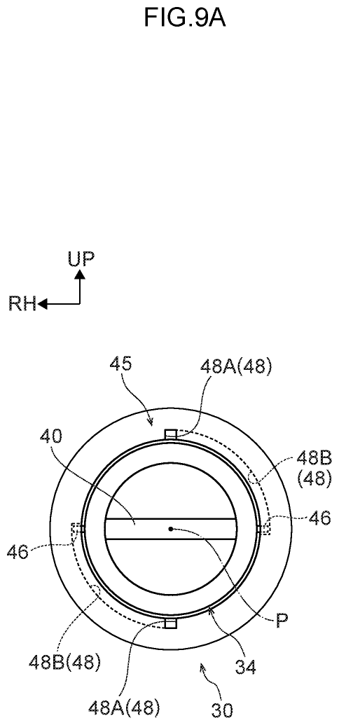

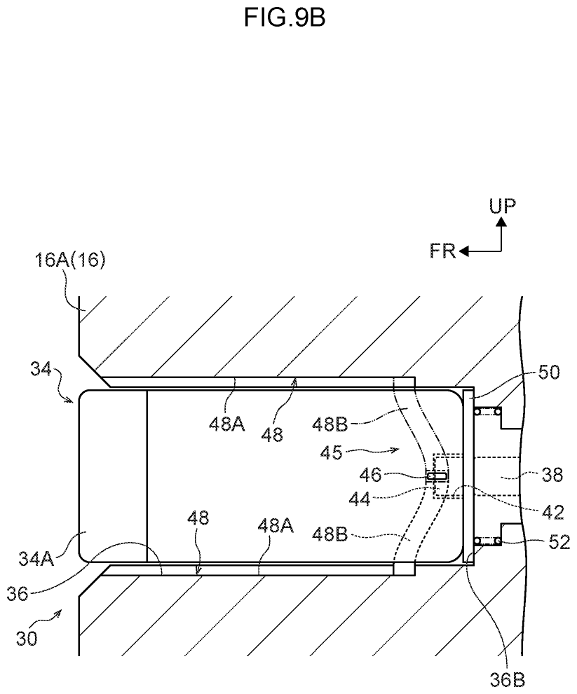

While the abutting plate 50 is abutted against the inward wall portion 36B, as illustrated in FIG. 8A and FIG. 9A, the hydrogen tank 34 is rotated by 90° in the direction of arrow A. Accordingly, the cam grooves 48B are formed as curves that cause the hydrogen tank 34 to rotate by 90° in the direction of arrow A while moving by the stroke S in the axial direction.

That is, rotary movement of the hydrogen tank 34 may be converted to linear movement in the axial direction by the shapes of the cam grooves 48B. A protrusion portion is formed in a terminal end portion of each cam groove 48B. The protrusion portion, which is not shown in the drawings, protrudes into the cam groove 48B. The engaging protrusions 46 may be moved past these protrusion portions. Thus, a “click” sensation is provided and the hydrogen tank 34 is put into a “locked” state by the engaging protrusions 46 moving past the protrusion portions.

As shown in FIG. 9B, in the state in which the abutting plate 50 abuts against the inward wall portion 36B, the connector portion 44 is engaged with the connector portion 38 in a vicinity of the fuel cell stack 32. In this state, a valve provided at the square hole portion 42, which is not shown in the drawings, is opened and hydrogen gas in the hydrogen tank 34 is supplied toward the fuel cell stack 32 via the connector portion 38.

In a state in which the hydrogen tank 34 has been removed from the hydrogen tank mounting portion 36, a state in which the abutting plate 50 is disposed at the original position thereof is maintained by the urging force of the spring 52.

### Operation and Effects of the Hydrogen Tank-Loaded Vehicle

Now, operation and effects of the hydrogen tank-loaded vehicle according to the present exemplary embodiment are described.

As shown in FIG. 5, in the hydrogen tank-loaded vehicle 10 according to the present exemplary embodiment, the tank storage portion 30 and the fuel cell stack 32 are provided. The tank storage portion 30 is disposed at the main body unit 16 that is movable by driving of the driving unit 14 (see FIG. 1), and the tank storage portion 30 structures a portion of the outer profile of the main body unit 16. The plural hydrogen tank mounting portions 36 are provided in the tank storage portion 30 along the height direction of the main body unit 16. The hydrogen tanks 34 can be removably stored in the hydrogen tank mounting portions 36.

In the present exemplary embodiment, the tank storage portion 30 structures a portion of the outer profile of the main body unit 16. The tank storage portion 30 is provided at the outer side of the main body unit 16 and is exposed to the exterior. Therefore, the hydrogen tanks 34 may be mounted and unmounted directly from outside the main body unit 16 (the hydrogen tank-loaded vehicle 10).

For example, although not shown in the drawings, if a tank storage portion is provided at a vehicle inner side of a hydrogen tank-loaded vehicle, it is difficult to mount or unmount each hydrogen tank 34 directly from outside the hydrogen tank-loaded vehicle. In the present exemplary embodiment, by contrast, because the tank storage portion 30 is provided at the outer side of the main body unit 16, mounting and unmounting operations of the hydrogen tanks 34 are simpler, and ease of operations is improved.

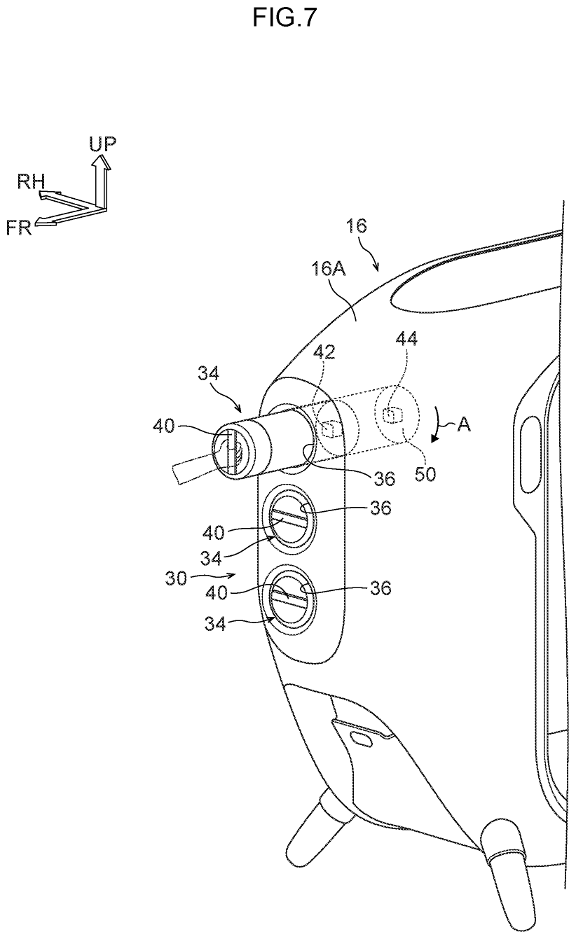

Moreover, because the tank storage portion 30 is provided at the outer side of the main body unit 16, as shown in FIG. 6 and FIG. 7, when each hydrogen tank 34 is mounted or unmounted, there is no obstacle in a movement path in the tank storage portion 30 of the hydrogen tank 34. Therefore, it is sufficient to reserve space in which the hydrogen tanks 34 can be stored in the tank storage portion 30, and the main body unit 16 may be formed compactly.

Although the tank storage portion 30 is exposed to the exterior in the present exemplary embodiment, it is clear that a cover (not shown in the drawings) may be provided at the front face side of the tank storage portion 30, which cover shields each hydrogen tank mounting portion 36 and is capable of opening and closing the tank storage portion 30. When this cover is provided, the tank storage portion 30 may be protected from rain, dust and the like during running of the main body unit 16. In some embodiments, when a cover is provided, the cover may be transparent, with a view to verifying locked states and lock release states of the hydrogen tanks 34, which are described below, from the exterior.

As shown in FIG. 1, the driving unit 14 is provided at the side of the main body unit 16 at which the front portion 16A is formed, and the tank storage portion 30 is provided at the upper side relative to the driving unit 14. Therefore, the hydrogen tank-loaded vehicle 10 may be formed compactly. In addition, at a time of collision of the main body unit 16, a direct collision of a collision body (not shown in the drawings) against the hydrogen tanks 34 stored in the tank storage portion 30 may be prevented.

Because each hydrogen tank 34 may be mounted and unmounted from the front side of the main body unit 16, although not shown in the drawings, safety of a mounting operator when mounting or unmounting the hydrogen tank 34 may be better assured than in a structure in which the hydrogen tank 34 is mounted from sideward of the main body unit 16.

The driving unit 14 may be coupled to and uncoupled from the main body unit 16. Therefore, in the state in which the driving unit 14 is uncoupled from the main body unit 16 as shown in FIG. 6, the hydrogen tanks 34 may be mounted and unmounted at the hydrogen tank mounting portions 36 more easily.

Because the width dimension of the main body unit 16 is formed to be smaller than the width dimension along the axial direction of the driving unit 14, the hydrogen tank-loaded vehicle 10 as a whole may be compactly formed.

In the present exemplary embodiment, as shown in FIG. 8A, FIG. 8B, FIG. 9A and FIG. 9B, the lock mechanism 45 that enables mounting or removal of the hydrogen tank 34 at each hydrogen tank mounting portion 36 is provided. Therefore, the hydrogen tanks 34 may be prevented from easily coming loose from the hydrogen tank mounting portions 36 during movements of the main body unit 16.

The lock mechanism 45 includes, as an example, the engaging protrusions 46 and the guide grooves 48. The engaging protrusions 46 are provided at the hydrogen tank 34 and the guide grooves 48 are provided at the hydrogen tank mounting portion 36. The engaging protrusions 46 engage with the guide grooves 48. Rotary movement of the hydrogen tank 34 in the circumferential direction can be converted to linear movement in the axial direction by the cam grooves 48B via the engaging protrusions 46.

Thus, as shown in FIG. 8A and FIG. 9A, in the process of the hydrogen tank 34 being inserted into and locked to the hydrogen tank mounting portion 36, the hydrogen tank 34 is turned 90° in the direction of arrow A.

The handle portion 40 is provided at the one end portion 34A of each hydrogen tank 34, and the hydrogen tank 34 may be handled via the handle portion 40. Prior to the locked state (in the lock release state), the handle portion 40 is disposed in the vertical direction as shown in FIG. 8A, and in the locked state, the handle portion 40 is disposed substantially in the horizontal direction as shown in FIG. 9A. Thus, locked states and lock release states of the hydrogen tanks 34 may be verified from the exterior via the handle portions 40.

The protrusion portions are formed in the cam grooves 48B, and a “click” sensation is provided by the engaging protrusions 46 provided at the hydrogen tank 34 moving past these protrusion portions. Thus, a user may feel that the hydrogen tank 34 is locked and may be given reassurance. It is sufficient that a user may recognize that the hydrogen tank 34 is in the locked state at the hydrogen tank mounting portion 36. Therefore, these protrusion portions are not necessarily required.

Regarding the lock mechanism 45, it is sufficient that the hydrogen tank 34 is locked and that locking is released in the state in which the hydrogen tank 34 is stored in the hydrogen tank mounting portion 36. Therefore, the lock mechanism 45 is not limited thus. For example, although not shown in the drawings, the hydrogen tank 34 may be rotatable in a state in which the hydrogen tank 34 abuts against the inward wall portion 36B of the hydrogen tank mounting portion 36, and removal of the hydrogen tank 34 may be disabled in a state in which the hydrogen tank 34 has been rotated. In this structure, groove portions in the circumferential direction of the hydrogen tank mounting portion 36 are formed in the hydrogen tank mounting portion 36 instead of the cam grooves 48B.

Locked states and lock release states of the hydrogen tanks 34 may be verified from the exterior by the orientations of the handle portions 40, but this is not necessarily required. For example, although not shown in the drawings, a display that shows locked states and lock release states of the hydrogen tanks 34 may be implemented at the tank storage portion 30.

As shown in FIG. 1, the driving unit 14 is provided at the front portion 16A side of the main body unit 16, and the tank storage portion 30 is provided at the upper side relative to the driving unit 14. However, relative positions of the driving unit 14 and the tank storage portion 30 are not necessarily limited thus.

The hydrogen tanks 34 may be mounted and unmounted from the front side of the main body unit 16, but this is not limiting. For example, structures are possible in which the hydrogen tanks 34 may be mounted and unmounted from the rear side of the main body unit 16, and structures are possible in which the hydrogen tanks 34 may be mounted and unmounted from sideward of the main body unit 16.

The cavity portion 25 penetrates through the main body unit 16 at the inner side of the frame portion 17 including the front wall portion 18, the rear wall portion 20, the upper wall portion 22 and the lower wall portion 24. The load 27 that is being transported (see FIG. 3) or the like may be accommodated in the cavity portion 25, but this is not limiting.

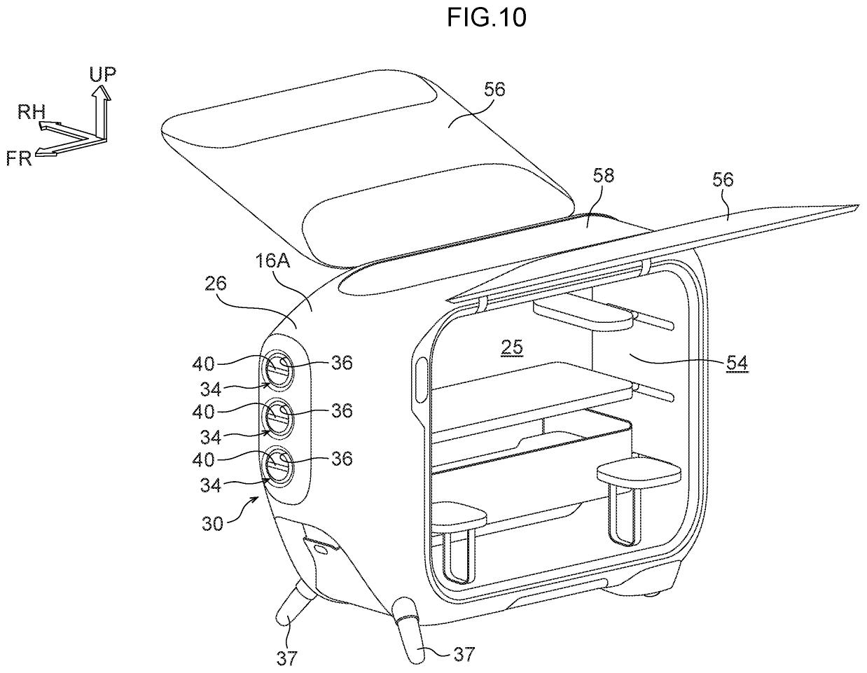

For example, although not shown in the drawings, a power supply may be provided that is capable of supplying electric power from the fuel cell stack 32 (see FIG. 5) to the cavity portion 25 (see FIG. 2), and the cavity portion 25 may be employed as a cabin interior space 54, a kitchen or the like, as illustrated in FIG. 10. Thus, versatility of the hydrogen tank-loaded vehicle 10 may be improved by the cavity portion 25 being employed for alternative purposes.

When the cavity portion 25 is employed as the cabin interior space 54, the cabin interior space 54 may be closed off by side wall portions 56 such that the interior of the cabin interior space 54 may selectively be an enclosed space. In this case, upper ends of the side wall portions 56 may be connected with an upper wall portion 58 via hinge portions. When the cabin interior space 54 is being opened up, the side wall portions 56 are turned toward the upper side about the hinge portions. In a state in which the side wall portions 56 have turned toward the upper side, the side wall portions 56 function as awnings.

As described above, in the above exemplary embodiment an example is illustrated in which hydrogen tanks are mounted at a small mobility vehicle that is autonomously driven by electric energy generated by a chemical reaction between hydrogen and oxygen. However, the hydrogen tanks may be mounted at hydrogen engine-equipped vehicles, hydrogen power generation devices, hydrogen-using drones, and other hydrogen-using devices that employ hydrogen.

The present disclosure is not limited to the exemplary embodiment described above. It will be clear that numerous modifications beyond the exemplary embodiment described above may be embodied within a technical scope not departing from the gist of the present disclosure.

What is claimed is:

1. A hydrogen tank-loaded vehicle comprising:
a tank storage portion disposed at a main body unit that is movable by driving of driving wheels, the tank storage portion structuring a portion of a vehicle outer profile, and a plurality of hydrogen tank mounting portions being provided at the tank storage portion in a height direction of the main body unit, each hydrogen tank mounting portion being configured to removably store a hydrogen tank; and
a fuel cell stack that is supplied with hydrogen from the hydrogen tanks and generates electric power.

2. The hydrogen tank-loaded vehicle according to claim 1, wherein the tank storage portion is exposed at the exterior.

3. The hydrogen tank-loaded vehicle according to claim 1, wherein the driving wheels are provided at a front side of the main body unit, and the tank storage portion is provided at an upper side relative to the driving wheels.

4. The hydrogen tank-loaded vehicle according to claim 2, wherein the driving wheels are provided at a front side of the main body unit, and the tank storage portion is provided at an upper side relative to the driving wheels.

5. The hydrogen tank-loaded vehicle according to claim 1, wherein the hydrogen tanks are configured to be removable from a front side of the main body unit.

6. The hydrogen tank-loaded vehicle according to claim 2, wherein the hydrogen tanks are configured to be removable from a front side of the main body unit.

7. The hydrogen tank-loaded vehicle according to claim 3, wherein the hydrogen tanks are configured to be removable from a front side of the main body unit.

8. The hydrogen tank-loaded vehicle according to claim 1, further comprising a lock mechanism that is configured to enable mounting or removal of each hydrogen tank at a hydrogen tank mounting portion.

9. The hydrogen tank-loaded vehicle according to claim 2, further comprising a lock mechanism that is configured to enable mounting or removal of each hydrogen tank at a hydrogen tank mounting portion.

10. The hydrogen tank-loaded vehicle according to claim 3, further comprising a lock mechanism that is configured to enable mounting or removal of each hydrogen tank at a hydrogen tank mounting portion.

11. The hydrogen tank-loaded vehicle according to claim 5, further comprising a lock mechanism that is configured to enable mounting or removal of each hydrogen tank at a hydrogen tank mounting portion.

12. The hydrogen tank-loaded vehicle according to claim 8, wherein the lock mechanism includes a cam groove provided at each hydrogen tank mounting portion, a projection portion provided at each hydrogen tank and being configured to engage with the cam groove, and the cam groove converting rotary movement rotating each hydrogen tank in a circumferential direction thereof to linear movement moving the hydrogen tank in an axial direction thereof.

13. The hydrogen tank-loaded vehicle according to claim 12, wherein a handle portion that enables handling is provided at one end in a length direction of each hydrogen tank, and a locked state or lock release state of the hydrogen tank by the locking mechanism can be verified from an exterior by a position of the handle portion relative to a hydrogen tank mounting portion.

14. The hydrogen tank-loaded vehicle according to claim 1, wherein the main body unit includes:
a frame portion that structures an outer profile of the main body unit, and
a cavity portion that penetrates in an axial direction of the driving wheels through an inner side of the frame portion.

15. The hydrogen tank-loaded vehicle according to claim 1, wherein a width dimension of the main body unit is smaller than a width dimension of the driving wheels in an axial direction thereof
